(19) United States
(12) Patent Application Publication
(10) Pub. No.: US 2003/0120828 A1
(43) Pub. Date: Jun. 26, 2003

(54) System and method for exchanging information between systems

(76) Inventors: Patrick R. Clark, White House, TN (US); Frederick Martin, Hendersonville, TN (US); Charless S. Foster, Antioch, TN (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/304,451

(22) Filed: Nov. 26, 2002

Related U.S. Application Data
(60) Provisional application No. 60/342,733, filed on Dec. 20, 2001.

(51) Int. Cl. G06F 15/16

(52) U.S. Cl. 709/319; 709/200

(57) ABSTRACT

A computer based system and method exchange information between systems. The system and method deliver the information from a first system to a hub application, receive the information at the hub and map the information at the hub into a predefined data structure. The system and method automatically update information stored on at least one other system using the predefined data structure.

### TECHNICAL FIELD

The present invention relates generally to information exchange, and more particularly, to a system and method for exchanging information between systems.

### BACKGROUND

Large entities, such as corporations, collect, gather and use an incredible amount of information during their day-to-day operations. Additionally, certain information may be used by different business functions within the same entity, e.g., customer information. Customer information may be used by for sales, for providing warranties and/or service, and for providing financing. Typically, the business organizations with the entity which provide these services maintain their own systems which are used in providing these services. The data stored within these systems must be gathered, entered and maintained (updated).

Historically, these systems have been independent and must be independently maintained. One problem is that each organization must gather, enter and maintain the data. This leads to a waste of resources in that often the organizations are duplicating the work of other organizations within the entity.

For example, several organizations may be gathering, entering, and maintaining separate databases containing the same or similar customer data.

One past solution to this problem was to link the systems together. For example, a financial organization uses a financial system in providing financing to customers, the system would require customer information. The sales organization's system also maintains customer information. One past solution would be to link these systems together, so that the systems could share data. Special software would be required to link the two different systems, adding cost to the system.

Whenever, a new system, i.e., a computer application, is added to the overall environment which requires information from these existing systems, a data communications link defining, inter alia, which information, the source, and the format of the information must be developed. For each new system, the data communications link must include a custom interface for the new system and a custom interface for each system with which the new system must communicate. This is costly and time-consuming, such that integration of the new system might be delayed or prevented.

The present invention is aimed at one or more of the problems addressed above.

### SUMMARY OF THE INVENTION

In a first aspect of the present invention, a computer based system is provided. The system includes a first system for generating information and at least one other system. A hub application is coupled to the first system and the at least one other system and is adapted to receive the information from the first system and map the information at the hub into a predefined data structure and to automatically update information stored on at least one other system using the predefined data structure.

In a second aspect of the present invention, a computer program product for exchanging information between systems, is provided. The computer program product includes computer readable program code means for delivering the information from a first system to a hub application, computer readable program code means for receiving the information at the hub and mapping the information at the hub into a predefined data structure, and computer readable program code means for automatically updating information stored on at least one other system using the predefined data structure.

In a third aspect of the present invention, a computer based method for exchanging information between systems, is provided. The method includes the steps of delivering the information from a first system to a hub application, receiving the information at the hub and mapping the information at the hub into a predefined data structure, and automatically updating information stored on at least one other system using the predefined data structure.

### BRIEF DESCRIPTION OF THE DRAWINGS

FIG. 1 is a block diagram of a system including a plurality of system applications and a hub application for controlling the exchange of information between the system applications, according to an embodiment of the present invention;

FIG. 2 is a block diagram of a system including a plurality of system applications and a hub application for controlling the exchange of information between the system applications, according to another embodiment of the present invention;

FIG. 3 is a block diagram of the hub of FIGS. 1 and 2, according to an embodiment of the present invention;

FIG. 4 is a first flow diagram of a method for exchanging information between at least two system applications, according to an embodiment of the present invention;

FIG. 5 is a second flow diagram of a method for exchanging information between at least two system applications, according to another embodiment of the present invention; and,

FIG. 6 is a block diagram of a computer program product for exchanging information between at least two system applications, according to another embodiment of the present invention.

### DETAILED DESCRIPTION

With reference to the drawings, and in operation, the present invention provides a computer based system 100, 200, computer program product 300, and method 400, 500 for exchanging information between systems 102. For example, the systems 102 may be enterprise systems used for various functions within a large corporation, university or other large entity.

The systems 102 are generally computer software applications implemented or running on mainframe computers, computer workstations, personal computers and the like. As explained below, one of the systems 102 generates information, e.g., customer information and the computer based system 100, 200, computer program product 300, and method 400, 500 is used to convert and distribute that information as needed to the other systems 102.

The information can be any type of information which may be used or shared between the systems, e.g., customer data, employee data, machine data, financial data, etc. . . . .

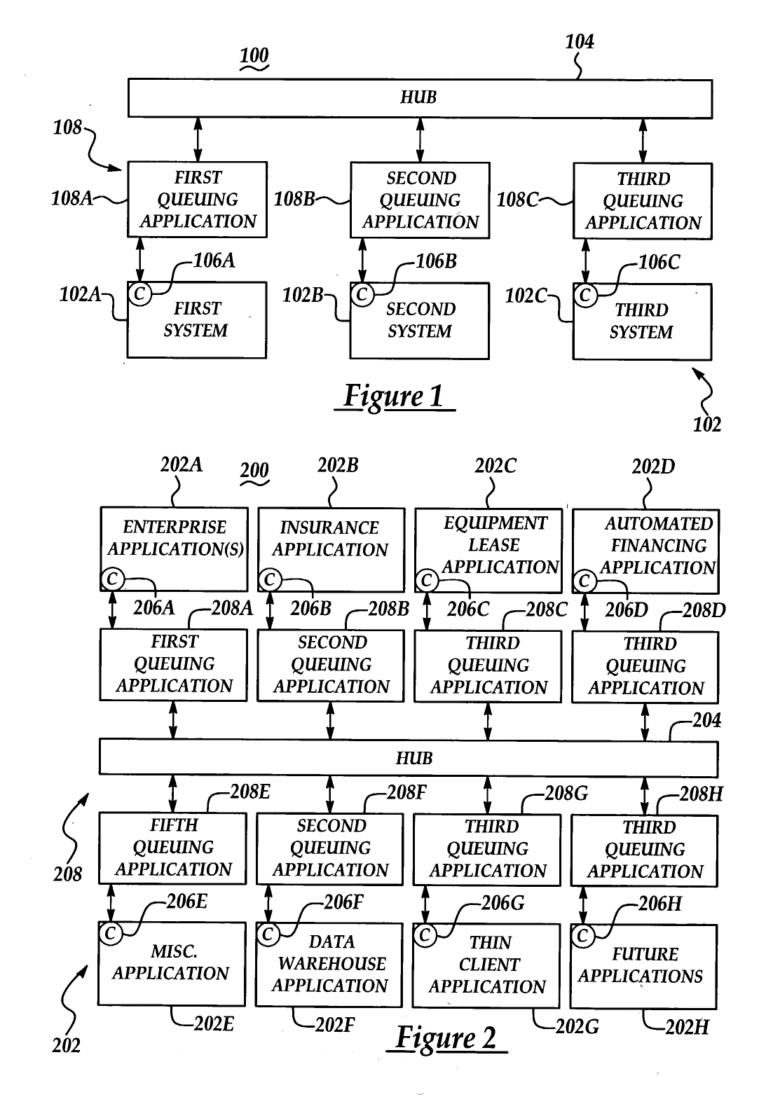

In a first aspect of the present invention, the computer based system 100 includes a plurality of systems or system applications 102. With specific reference to FIG. 1, a first system 102A generates information and at least one other system 102B, 102C utilizes the information. The exemplary computer based system 100 shown in FIG. 1 includes a second system 102B and a third system 102C. It should be noted that the discussion below is focused on information being generated by the first system 102A and distributed to the second system 102B and/or the third system 102C. However, the second and third systems 102B, 102C may also be generating other information for distribution to one of the other systems 102A, 102B, 102C.

In one aspect of the present invention, the computer based system 100 includes a hub computer program application or hub 104 which is coupled to the first system 102A, 102B, 102C and is adapted to receive the information from the first system 102A, and map the information at the hub 104 into a predefined data structure and to automatically update information stored on the second system 102B, the third system 102C or both, using the predefined data structure.

In another aspect of the present invention, each system or application 102 utilizes a defined data format for information. The hub computer program application 104 also utilizes a defined data format. In one embodiment, the data format utilized by the hub computer program application 104 is embodied in the data structure. In the another aspect of the present invention, the hub computer program application 104 receives information from the systems 102 and translates the information from the data format of the sending system 102 into the hub's data format. Additionally, information sent to one of the systems 102 by the hub computer program application 104 is translated from the hub's data format into the data format utilized by the receiving system 102. For example, information delivered from the first system 102A to the hub computer program application is translated from a first data format (utilized by the first system 102A) to a second data format, e.g., as defined by the data structure. Furthermore, information delivered from the hub computer application 104 to the second system 102B is translated from the second data format to a third data format. In one embodiment, the steps of translating between data formats is performed by mapping data into and out of the data structure.

The computer based system 100 is part of a computer network which is comprised of a plurality of computers, including mainframe computers, workstations, personal computers, thin clients. Systems 102 may be implemented on a single computer or across several computers. The hub computer program application 104 may be run on its own computer or on the same computer as one of the systems or applications 102.

In one aspect of the present invention, each system 102A, 102B, 102C includes a connecting computer program application or connection application 106A, 106B, 106C which is adapted to control communication between the systems 102A, 102B, 102C and the hub computer program application 104. In one embodiment, the connection application 106A, 106B, 106C is embodied in an Application Program Interface (API).

In one aspect of the present invention, the computer based system 100 is synchronous. For example, in one embodiment, the information from the first system 102A is sent to the hub at predetermined intervals. Additionally, the at least one other system, i.e., the second system 102B, the information stored on the at least one other system is updated at predetermined intervals.

In another aspect of the present, the computer based system 100 is asynchronous. In other words, information is not exchanged on predetermined intervals, but rather is updated in packets.

The computer based system 100 uses a publish and subscribe process. In one embodiment, the at least one other system 102B, 102C is adapted to generate a request for an update. The hub application 104 is adapted to receive the request and automatically update the information on the at least one other system 102B, 102C using the predefined data structure in response to receiving the request.

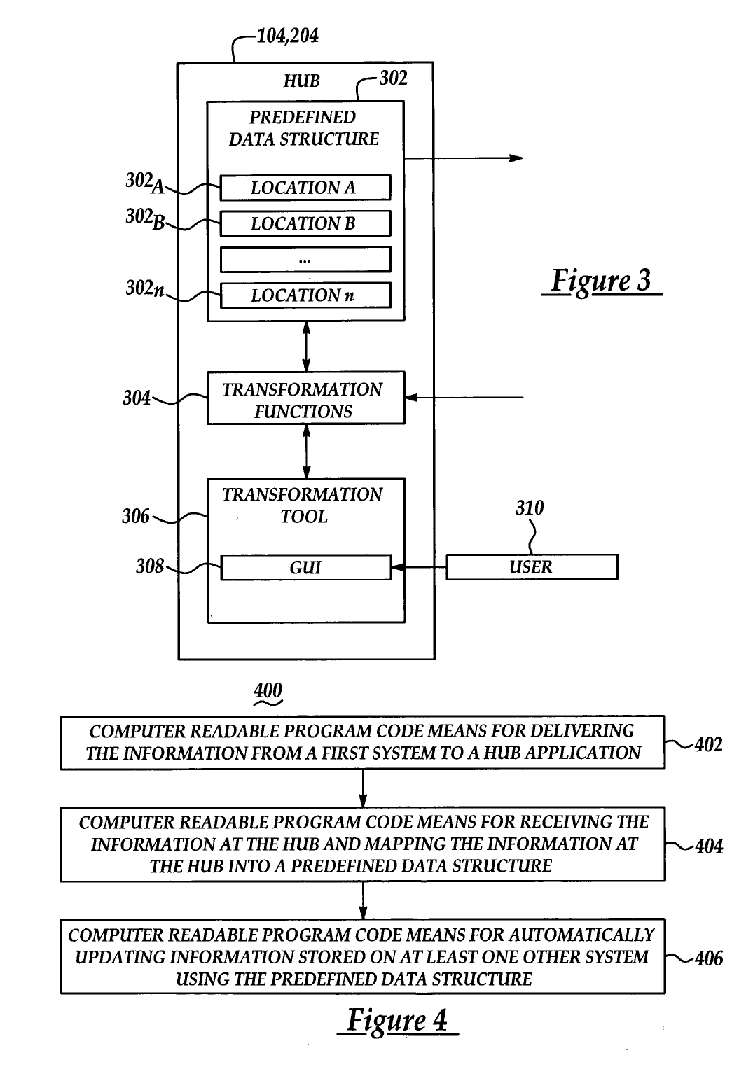

In one aspect of the present invention, the hub application 104 is adapted to automatically update the information stored on at the least one other system 102B, 102C using the predefined data structure using direct mapping. With reference to FIG. 3, the predefined data structure 302 includes a plurality of predefined locations 302A, 302B, 302C, . . . 302ₙ. The information to be exchanged is composed of a plurality of data elements. Each data element is mapped to a predefined location within the data structure 302.

In another aspect of the present invention, the computer based system 100 includes queuing software applications 108 which couple to the applications 102 to the hub 104. Returning to FIG. 1, the exemplary computer based system 100 shown includes first, second, and third queuing applications 108A, 108B, 108C which couple the hub 104 to the first, second and third applications, respectively.

In one embodiment, the queuing application 108 are implemented using a messaging computer program product. One suitable messaging computer program product is available from IBM of Armonk, N.Y. as WebSphere MQ Queue Manager (formerly, MQSeries Queue Manager). In one aspect of the present invention, the messaging computer program product 108 provides once-only guaranteed delivery. In another aspect of the present invention, the messaging computer program product provides 108 prioritizing of message delivery.

In another aspect of the present invention, the hub application 104 includes a set of transformation functions 304 for receiving the information at the hub 104 and mapping the information at the hub 104 into the predefined locations 302A, 302B, . . . 302ⁿ of the predefined data structure 102. With specific reference to FIG. 3, the hub application 104 includes a transformation tool 306 adapted to allow a user 310 to define the set of transformation functions 304. In one embodiment, the transformation tool 306 is manipulated by the user 310 via a graphical user interface or GUI 308.

In one aspect of the present invention, the graphical user interface 308 is adapted to allow the user 310 to define the set of transformation functions 304 by choosing the transformations functions to be included from a plurality of available transformation functions. In another aspect of the present invention, the transformation tool 304 is adapted to allow the user 310 to create custom transformation functions. The user 310 is allowed to select transformation functions from the plurality of available transformation functions which include the predefined transformation functions and the custom transformation functions.

With reference to FIG. 2, an exemplary computer based system 200 for a large enterprise is shown. The enterprise may utilize a number of legacy and/or new systems or applications 202, including a combination of hardware and software including:

one or more enterprise applications 202A,

an insurance application 202B,

an equipment lease application 202C,

an automated financing application 202D,

one or more miscellaneous applications 202E,

a data warehouse application 202F,

one or more thin client applications 202G, and,

any future applications 202H.

A hub computer application or hub 204 is coupled to each of the systems or applications 202A, 202B, 202C, 202D, 202E, 202F, 202G, 202H. The hub 204 is adapted to receive information from one of the systems 202A, 202B, 202C, 202D, 202E, 202F, 202G, 202H, map the information at the hub 204 into a predefined data structure and to automatically update information stored on at least one other system 202A, 202B, 202C, 202D, 202E, 202F, 202G, 202H using the predefined data structure in response to receiving the request.

First, second, third, fourth, fifth, sixth, seventh and eighth queuing applications 206A, 206B, 206C, 206D, 206E, 206F, 206G, 206H couple the hub 204 to the enterprise applications 202A, the insurance application 202B, the equipment lease application 202C, the automated financing application 202D, the miscellaneous applications 202E, the data warehouse application 202F, the thin client applications 202G, and any future applications 202H, respectively. Each system 206A, 206B, 206C, 206D, 206E, 206F, 206G, 206H includes a connecting computer application 208A, 208B, 208C, 208D, 208E, 208F, 208G, 208H (see above).

With reference to FIG. 4, in a second aspect of the present invention, the system 100, 200 is implemented in a computer program product 400. In one embodiment, the computer program product 400 includes computer readable program code means 402 for delivering the information from the first system 102A to the hub application 104. A computer readable program code means 404 receives the information at the hub 104 and maps the information at the hub 104 into a predefined data structure 302. The computer program product 400 also includes computer readable program code means 406 for automatically updating information stored on the at least one other system 102B, 102C using the predefined data structure 302.

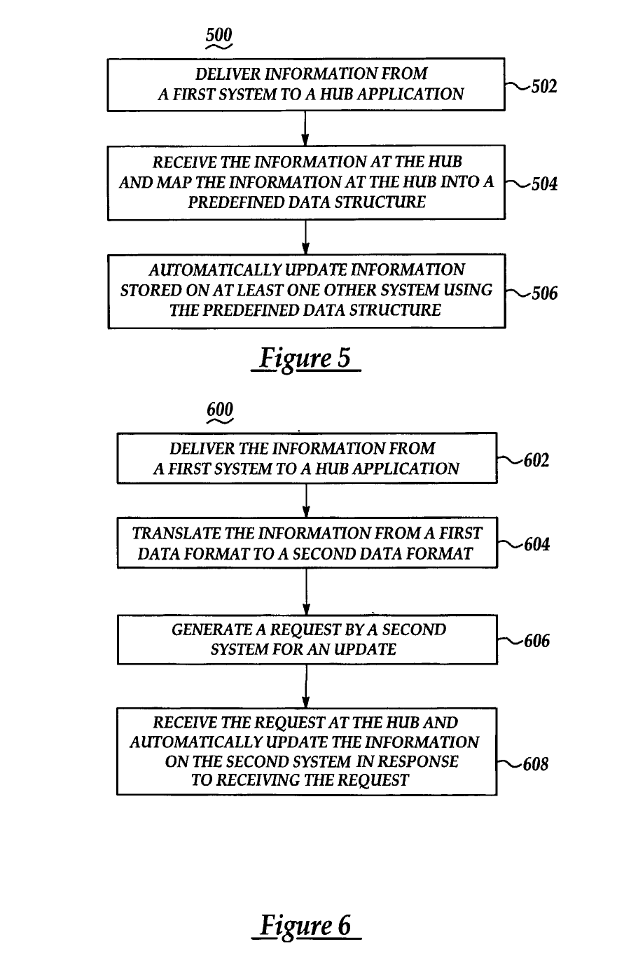

With reference to FIG. 5, in a third aspect of the present invention, a method 500 exchanges information between systems 102 In a first process block 502, information is delivered from the first system 102A to the hub application 104. In a second process block 504, the information is received at the hub and mapped into a predefined data structure. In a third process block 506, information stored on at least one other system is automatically updated using the predefined data structure.

With reference to FIG. 6, a second method 600 according to another embodiment of the present invention will now be discussed. In a first process block 602, the information is delivered from the first system 102A to the hub application 104. In a second process block 604, the information is translated from a first data format to a second data format. In a third process block 606, a request is generated by a second system 102B for an update. In a fourth process block 608, the request is received at the hub 104 and the information on the second system 102B is automatically updated in response to receiving the request.

### Industrial Applicability

With specific reference to the FIGS. 1, the present invention provides a system 100, 200, computer program product 400 and method 500, 600 for exchanging information between systems 102, 202. Typically, some of the systems 102, 202 are legacy systems, in other words, are currently existing systems and have been used for a number of years. The systems 102, 202 generally have different functions/purposes and are utilized by different organizations within an enterprise, such as a large organization or company.

Although the systems 102, 202 serve different functions, several of the systems 102, 202 may use the same or similar data, e.g., customer information. The present invention serves as a universal translator between the systems 102, 202 and is able to automatically update or synchronize the information stored on the systems 102, 202. Thus, when the information is added or updated on one systems 102, 202, the present invention automatically updates (either synchronously or asynchronously) the information on other systems 102, 202.

Additionally, when a new legacy system or new system is added to the overall computer system 100, 200 and the new system must share information with one or more of the other systems 102, 202, only the interface between the new system (legacy or otherwise) must be written. A new interface between the new system and all the systems with which it must exchange information does not need to be written.

Other aspect and features of the present invention can be obtained from a study of the drawings, the disclosure, and the appended claims.

What is claimed is:

1. A computer based method for exchanging information between systems, including the steps of:
delivering the information from a first system to a hub application;
receiving the information at the hub and mapping the information at the hub into a predefined data structure; and,
automatically updating the information stored on at least one other system using the predefined data structure.

2. A method, as set forth in claim 1, wherein the step of mapping the information the information into a predefined data structure translates the information from a first data format to a second data format.

3. A method, as set forth in claim 2, wherein the step of automatically updating the information stored on at least one other system using the predefined data structure translates the information from the second data format to a third data format.

4. A method, as set forth in claim 1, wherein the information from the first system is sent to the hub at predetermined intervals.

5. A method, as set forth in claim 1, wherein the step of automatically updating information stored on the at least one other system is performed at predetermined intervals.

6. A method, as set forth in claim 1, wherein the information is customer data.

7. A method, as set forth in claim 1, wherein the step of automatically updating the information stored on the at least one other system using the predefined data structure is performed using direct mapping.

8. A method, as set forth in claim 1, wherein the step of automatically updating the information stored on the at least one other system using the predefined data structure is performed using a publish and subscribe process.

9. A method, as set forth in claim 1, wherein the information is composed of data elements.

10. A method, as set forth in claim 1, wherein a data element in the information is mapped to a predefined location with the data structure.

11. A method, as set forth in claim 1, including the steps of:
generating a request by the second system for an update; and,
receiving the request at the hub and automatically updating the information on the second system using the predefined data structure in response to receiving the request.

12. A method, as set forth in claim 1, wherein the step of delivering the information from the first system to the hub application is performed by a queuing software application.

13. A method, as set forth in claim 1, wherein information is delivered to and from the systems using a messaging computer program product.

14. A method, as set forth in claim 13, including the step of providing once-only guaranteed delivery.

15. A method, as set forth in claim 13, including the step of providing prioritizing of message delivery.

16. A method, as set forth in claim 1, wherein the step of receiving the information at the hub and mapping the information at the hub into a predefined data structure is performed by a set of transformation functions.

17. A method, as set forth in claim 16, including the step of providing a transformation tool to allow a user to define the set of transformation functions.

18. A method, as set forth in claim 17, including the step of providing a user interface for interaction with the user to allow the user define the set of transformation functions by choosing the transformations functions to be included from a plurality of available transformation functions.

19. A method, as set forth in claim 18, including the step of allowing the user to create custom transformation functions.

20. A method, as set forth in claim 19, wherein the plurality of available transformation functions includes predefined transformation functions and the custom transformation functions.

21. A method, as set forth in claim 1, wherein the step of updating the information stored on at least one other system using the predefined data structure is performed in response to receiving a request from the at least one other system.

22. A computer based method for exchanging information between systems, including the steps of:
delivering the information from a first system to a hub application;
translating the information from a first data format to a second data format; and,
generating a request by a second system for an update; and,
receiving the request at the hub;
responsively translating the information from the second data format to a third data format; and
automatically updating the information on the second system in response to receiving the request.

23. A computer based system, comprising:
a first system for generating information;
at least one other system; and,
a hub application, coupled to the first system and the at least one other system, for receiving the information from the first system and mapping the information at the hub into a predefined data structure and automatically updating the information stored on at least one other system using the predefined data structure.

24. A system, as set forth in claim 23, wherein the computer based system translates the information received from the first system from a first data format to a second data format by mapping the information into the predefined data structure.

25. A system, as set forth in claim 23, wherein the computer based system translates the information from the second data format to a third data format prior to updating the information stored on at least one other system.

26. A system, as set forth in claim 23, wherein the information from the first system is sent to the hub at predetermined intervals.

27. A system, as set forth in claim 23, wherein the information stored on the at least one other system is updated at predetermined intervals.

28. A system, as set forth in claim 23, wherein the information is customer data.

29. A system, as set forth in claim 23, wherein hub application is adapted to automatically update the information stored on at the least one other system using the predefined data structure using direct mapping.

30. A system, as set forth in claim 23, wherein hub application is adapted to automatically update the information stored on the at least one other system using the predefined data structure using a publish and subscribe process.

31. A system, as set forth in claim 23, wherein the information is composed of data elements.

32. A system, as set forth in claim 23, wherein a data element in the information is mapped to a predefined location with the data structure.

33. A system, as set forth in claim 23, wherein a second system is adapted to generate a request for an update, and the hub application is adapted to receive the request at the hub and automatically update the information on the second system using the predefined data structure in response to receiving the request.

34. A system, as set forth in claim 23, including a queuing software application adapted to deliver the information from the first system to the hub application.

35. A system, as set forth in claim 23, wherein information is delivered to and from the systems using a messaging computer program product.

36. A system, as set forth in claim 35, wherein the messaging computer program product provides once-only guaranteed delivery.

37. A system, as set forth in claim 35, wherein the messaging computer program product provides prioritizing of message delivery.

38. A system, as set forth in claim 23, including a set of transformation functions for receiving the information at the hub and mapping the information at the hub into the predefined data structure.

39. A system, as set forth in claim 38, including a transformation tool adapted to allow a user to define the set of transformation functions.

40. A system, as set forth in claim 39, wherein the transformation tool includes a user interface for interaction with the user and being adapted to allow the user to define the set of transformation functions by choosing the transformations functions to be included from a plurality of available transformation functions.

41. A system, as set forth in claim 40, wherein the transformation tool is adapted to allow the user to create custom transformation functions.

42. A system, as set forth in claim 41, wherein the plurality of available transformation functions includes predefined transformation functions and the custom transformation functions.

43. A computer based system, comprising:
a first system for generating information, the first system being adapted to translate the information from a first data format to a second data format;
at least one other system being adapted to generating a request for an update; and,
a hub application coupled to the first system and at least one other system and being adapted to receive the information from the first system and map the information at the hub into a predefined data structure and to automatically update information stored on at least one other system using the predefined data structure in response to receiving the request.

44. A computer program product for exchanging information between systems, comprising:
computer readable program code means for delivering the information from a first system to a hub application;
computer readable program code means for receiving the information at the hub and mapping the information at the hub into a predefined data structure; and,
computer readable program code means for automatically updating information stored on at least one other system using the predefined data structure.
